(19) United States
(12) Patent Application Publication
(10) Pub. No.: US 2010/0127673 A1
(43) Pub. Date: May 27, 2010

(54) Power feed system and voltage stabilization method

(75) Inventors: Yasuhiro Iino, Kawasaki (JP); Tamio Shimizu, Kawasaki (JP); Takahiro Miyazaki, Kawasaki (JP); Toshifumi Washio, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/656,190

(22) Filed: Jan. 20, 2010

Related U.S. Application Data
(63) Continuation of application No. PCT/JP2007/064682, filed on Jul. 26, 2007.

(51) Int. Cl. G05F 1/563

(52) U.S. Cl. 323/271

(57) ABSTRACT

A voltage stabilizing circuit is provided between an insulated converter and a non-insulated converter. When an input voltage Vin from the insulated converter rises, a base current Ib is caused to flow into a transistor via a capacitor, thereby causing a collector current Ic that is hfe times larger than the base current Ib to flow into a collector of the transistor. As a result, a capacitance C of the capacitor is caused to produce approximately the same effect as that produced in a case where a capacitor whose capacitance is equivalent to a value obtained by multiplying the capacitance by the current amplification factor hfe of the transistor is inserted between a power supply line and a ground.

### CROSS-REFERENCE TO RELATED APPLICATION

This is a continuation application of PCT/JP2007/064682, filed on Jul. 26, 2007.

### TECHNICAL FIELD

The present invention is related to a power feed system used for network equipment, server equipment or the like and to a voltage stabilization method in the power feed system.

### BACKGROUND ART

Among pieces of network equipment and server equipment, some are provided with a power feed system that stably supplies power to a load whose load current changes greatly at a high speed. In this type of power feed system, in general, a capacitor is provided between a power supply line and a ground in order to stabilize the voltage that changes as the load current changes.

FIG. 5 is a diagram that illustrates a circuit structure of a conventional power feed system.

A power feed system 100 illustrated in FIG. 5 includes: an insulated converter 10; a non-insulated converter 20; a power supply line 31; a ground 32; a capacitor 110 provided between the power supply line 31 and the ground 32; and a capacitor 120 provided on the output side of the non-insulated converter 20. The respective electrostatic capacities of the capacitors 110 and 120 are comparatively large and therefore, the sizes of these capacitors 110 and 120 are comparatively large as well.

A power supply 200 with comparatively high voltage Ein (e.g. DC voltage of 48V) is connected to the insulated converter 10. The insulated converter 10 is a so-called step-down type of DC-DC converter that receives power from the power supply 200 of voltage Ein and then generates power of voltage Vin (e.g. DC voltage of 12V) which is lower than the voltage Ein. Although a circuit structure of the insulated converter 10A will be described later, the insulated converter 10A is formed, in brief, such that the comparatively high voltage Ein is applied from the power supply 200 to the insulated converter 10 and thus the insulated converter 10 is implemented on, for example, a circuit board where there are formed a wiring pattern and the like laid out to be able to sufficiently support this high voltage Ein. Also, galvanic isolation is established between input and output of the insulated converter 10 by an isolation transformer which will be described later. For this reason, the insulated converter 10 is excellent in tolerance to an external surge such as lightning.

The power of the voltage Vin produced by the insulated converter 10 is saved in the capacitor 110 and supplied to the non-insulated converter 20. The non-insulated converter 20 is a step-down type of DC-DC converter that receives the power of the voltage Vin from the insulated converter 10 and then generates power of voltage VL (e.g. DC voltage of 3V) which is lower than the voltage Vin. Although the structure of the non-insulated converter 20 will be described later, the non-insulated converter 20 is formed, in brief, such that the comparatively low voltage Vin is applied from the insulated converter 10 to the non-insulated converter 20 and thus the non-insulated converter 20 is implemented on, together with the capacitors 110 and 120 and a load 300, for example, a circuit board where a wiring pattern and the like for transmitting logic signals are formed.

Here, the structures of the insulated converter 10 and the non-insulated converter 20 will be briefly described. Incidentally, a structural diagram of the insulated converter 10 and the non-insulated converters 20 illustrated in FIG. 5 is equivalent to a conceptual diagram for describing the principles of an insulated converter and a non-insulated converter provided in a conventional power feed system.

The insulated converter 10 includes: an isolation transformer 11 connected to the power supply 200 of voltage Ein; diodes 12 and 13; a choke coil 14; a capacitor 15; a control circuit 16; and a switching element 17. The control circuit 16 drives the isolation transformer 11 by turning on and off the switching element 17 so that the voltage value of the voltage Vin from the insulated converter 10 remains constant. By this driving, alternating voltage is induced to the isolation transformer 11. This alternating voltage is rectified by the diodes 12 and 13 and stabilized by the choke coil 14 and the capacitor 15, and then this stabilized voltage is output as power of the voltage Vin. This power of the voltage Vin is saved in the capacitor 110 and supplied to the non-insulated converter 20.

Meanwhile, the non-insulated converter 20 includes a control circuit 21, a switching element 22, a diode 23, a choke coil 24, and a capacitor 25. The control circuit 21 turns on and off the switching element 22 so that the voltage value of the voltage VL from the non-insulated converter 20 remains constant, thereby supplying the power of the voltage Vin to a power stabilizer made of the diode 23, the choke coil 24 and the capacitor 25 where the power of the voltage Vin is stabilized. This stabilized power is then output as power of the voltage VL. This power of the voltage VL is saved in the capacitor 120 and supplied to the load 300.

Here, in the capacitor 110 provided between the power supply line 31 and the ground 32 and in the capacitor 120 provided on the output side of the non-insulated converter 20, the power appropriate to the capacitances of the capacitors 110 and 120 are accumulated. Therefore, even when a change occurs in the load current flowing into the load 300, the load 300 can be stably supplied with the power.

Also, for example, Patent Citation 1 proposes a power feed system that includes a dummy load circuit provided between: a chopper circuit that controls power by accumulating and releasing electric energy with an inductance element by turning DC voltage on and off; and a switching circuit that converts the DC voltage whose power has been controlled by the chopper circuit into alternating voltage and supplies AC power to a discharge lamp. The dummy load circuit feeds a dummy current to the inductance element by operating for a period of time during which the switching circuit rests. In this power feed system, by feeding the dummy current to the inductance element while the switching circuit is taking a rest, the electric current flowing into the inductance element is prevented from being interrupted for a period of time during which the switching circuit is at rest. This prevents occurrence of audible noises from the inductance element.
[Patent Citation 1] Japanese Laid-open Patent Publication No. 07-295666

Here, in the power feed system 100 described with reference to FIG. 5, in order to stably supply power to the load 300, it is necessary to provide the capacitor 110 between the power supply line 31 and the ground 32 and also to provide the capacitor 120 on the output side of the non-insulated converter 20. In recent years, as the so-called digital load such as CPU (Central Processing Unit) has become lower in voltage and larger in current and operated at a higher speed, the capacitance of a capacitor provided between a power supply line and a ground has further increased, for example, to a level between several thousand μF and tens of thousands of μF. Meanwhile, devices have become smaller in size and higher in density, thereby limiting the space (physical circuit area) for disposing a capacitor. Therefore, there is such a problem that it is difficult to dispose a capacitor of sufficiently large capacitance in the power feed system 100 described above in view of physical circuit area and cost.

Also, according to Patent Citation 1, although occurrence of audible noises is prevented in the power feed system proposed in this document, this document mentions nothing related to stable power supply to the load. Here, in a case where the power cannot be stably supplied to the load, there is a possibility that an electronic circuit or the like operating as the load may malfunction and thus, techniques for stably supplying the power to the load are extremely important.

### DISCLOSURE OF INVENTION

A power feed system achieving the above object is a power feed system including:

a first converter that receives power from a power source of a first voltage and produces power of a second voltage lower than the first voltage;

a second converter that receives the power of the second voltage from the first converter, produces power of a third voltage lower than the second voltage, and supplies the power of the third voltage to a load; and

a voltage stabilizing circuit that is provided between the first converter and the second converter and stabilizes the second voltage by monitoring a fluctuation of the second voltage, forming a current path between a power supply line of the second voltage and a ground, and adjusting the amount of a current flowing in the current path according to a result of the monitoring.

The power feed system of the present invention is a system that stabilizes, when a change occurs in a load current flowing into the load, the second voltage from the first converter by adjusting the amount of a current flowing in the current path formed between the power supply line and the ground, and then supplies the power of the stabilized second voltage to the second converter that in turn supplies the power of the third voltage lower than the second voltage to the load. Here, the voltage stabilizing circuit that stabilizes the second voltage by adjusting the amount of a current flowing in the current path formed between the power supply line and the ground can be formed by a circuit element of comparatively small size as represented in an embodiment. For this reason, there is no need to provide a capacitor of large size between the power supply line and the ground. Therefore, for example, even if the level of stability of this voltage stabilizing circuit is insufficient to some extent, it is possible to stably supply the power to the load while keeping the circuit area and a cost increase small by providing a capacitor of small size between the power supply line and the ground. Alternatively, when sufficient stability is achieved by having this voltage stabilizing circuit, it is possible to stably supply the power to the load while maintaining the circuit area and a cost increase small without providing a capacitor between the power supply line and the ground.

Also, the power feed system of the present invention stabilizes the second voltage that is an output of the first converter, by having the voltage stabilizing circuit provided between the first converter and the second converter.

Here, depending on the circuit structure of this voltage stabilizing circuit, the second voltage may not be completely stabilized even if the voltage stabilizing circuit is provided, and there is a possibility that a fluctuation of, for example, about 2 VP to P at the maximum may occur at the time when the load suddenly changes. Meanwhile, in a case where an electronic circuit or the like acting as the load is formed by a CPU or the like that operates by receiving a supply of low power of 3V for example, it may be useless to provide a power line of this 3V with a voltage stabilizing circuit that is likely to produce a fluctuation of 2 VP to P at the maximum. In the power feed system of the present invention, the voltage stabilizing circuit is provided on the output side of the first converter where voltage is comparatively high, namely on the input side of the second converter. Therefore, such a comparatively high voltage is sufficiently stabilized, and this stabilized voltage is further stabilized via the second converter, making it possible to supply the power of stable voltage even when the load abruptly changes.

Further, in the power feed system of the present invention, the first converter with galvanic insulation between input and output is provided and thus, the power feed system of the present invention is superior in terms of tolerance to a surge voltage caused externally. Furthermore, the second converter, which is supplied with the power of the second voltage stabilized by the voltage stabilizing circuit from the first converter, is excellent in load responsiveness, and the first converter and the second converter are DC-DC converters of step-down type. Therefore, it is possible to preferably support a digital load such as a CPU that operates at a high speed with low voltage and heavy current.

Here, preferably, the voltage stabilizing circuit includes:

a capacitor and a first resistance that are connected in series between the power supply line and the ground, the capacitor being on a power-supply-line side and the first resistance being on a ground side;

a diode whose cathode is connected to a connection node between the capacitor and the first resistance and whose anode is connected to the ground; and

a second resistance and an active element that are connected in series between the power supply line and the ground, the active element including a control terminal connected to the connection node and changing impedance according to a voltage of the connection node.

Further, preferably, the first converter is an insulated converter with galvanic insulation between input and output, and the second converter is a non-insulated converter.

In the present invention, typically, an insulated converter with galvanic insulation between input and output is employed as the first converter, and a non-insulated converter is preferably employed as the second converter.

Furthermore, preferably, the active element is any one selected from among active elements such as a transistor, a FET, an IGBT and a SIT.

With such a voltage stabilizing circuit, when, for example, the second voltage rises, the base current flows into the active element (described here by taking a transistor as an example) through a capacitor, thereby causing a collector current of the current amplification factor hfe times larger than the base current to flow into the collector of the transistor. Then, it is possible to make the capacitance of the capacitor produce about the same effect as that produced in a case where a capacitor whose capacitance is equivalent to the capacitance multiplied by the current amplification factor hfe of the transistor is inserted between the power supply line and the ground. Therefore, it is possible to form the voltage stabilizing circuit with a circuit element such as a capacitor, transistor or the like of small size, making it possible to stably supply the power to the load while keeping the circuit area and a cost increase small.

Also, a voltage stabilization method of the present invention achieving the above object is a voltage stabilization method in a power feed system that includes a first converter that receives power from a power source of a first voltage and produces power of a second voltage lower than the first voltage and a second converter that receives the power of the second voltage from the first converter, produces power of a third voltage lower than the second voltage, and supplies the power of the third voltage to a load, the voltage stabilization method comprising:

monitoring a fluctuation of the second voltage, forming a current path between a power supply line of the second voltage and a ground, and adjusting the amount of a current flowing in the current path according to a result of the monitoring.

The voltage stabilization method of the present invention is a method of: monitoring fluctuation of the second voltage from the first converter; forming a current path between the power supply line of the second voltage and the ground; and adjusting the amount of a current flowing in the current path according to the result of the monitoring. Here, a circuit for adjusting the amount of a current flowing in the current path necessary for realizing the voltage stabilization method of the present invention can be formed by a circuit element of comparatively small size. Thus, it is possible to provide a voltage stabilization method capable of stably supplying the power to the load while keeping the circuit area and a cost increase small.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram that illustrates a circuit structure of a power feed system according to one embodiment of the present invention;

FIG. 2 is a diagram for explaining the structure and operation of a voltage stabilizing circuit illustrated in FIG. 1;

FIG. 3 is a diagram illustrating a waveform of each part in the voltage stabilizing circuit illustrated in FIG. 2;

FIG. 4 is a diagram that illustrates the structure of a voltage stabilizing circuit different from the voltage stabilizing circuit illustrated in FIG. 1 and FIG. 2; and

FIG. 5 is a diagram that illustrates a circuit structure of a conventional power feed system.

### BEST MODE FOR CARRYING OUT THE INVENTION

An embodiment of the present invention will be described.

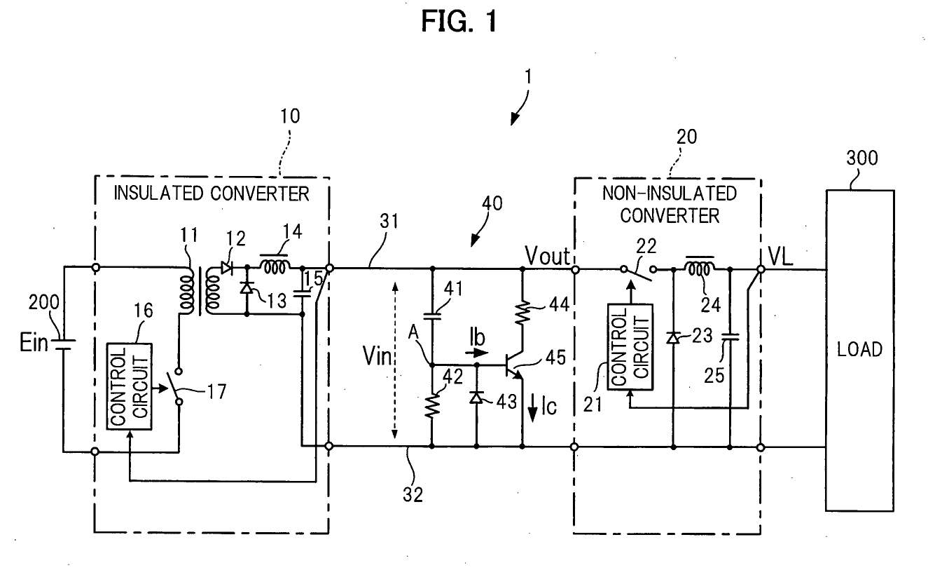

FIG. 1 is a diagram that illustrates a circuit structure of a power feed system according to one embodiment of the present invention.

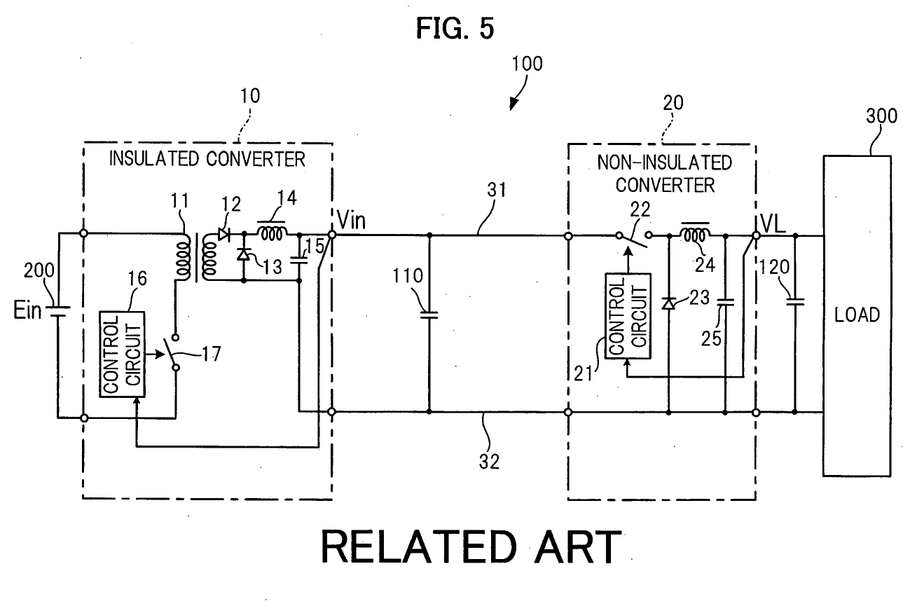

Incidentally, the same components as those of the power feed system 100 described earlier and illustrated in FIG. 5 are indicated with the same reference characters as those used in the power feed system 100, and points different from the power feed system 100 will be described.

The power feed system 1 illustrated in FIG. 1 is different from the power feed system 100 illustrated in FIG. 5 in that the capacitor 110 illustrated in FIG. 5 is replaced with a voltage stabilizing circuit 40 and the capacitor 120 illustrated in FIG. 5 is deleted. Also, one embodiment of the voltage stabilization method of the present invention is applied to the power feed system 1 illustrated in FIG. 1.

The power feed system 1 illustrated in FIG. 1 includes an insulated converter 10 (equivalent to the first converter according to the present invention) that receives a supply of power from a power supply 200 of voltage Ein (equivalent to the first voltage according to the present invention, e.g. DC voltage of 48V) and produces power of voltage Vin (equivalent to the second voltage according to the present invention, e.g. DC voltage of 12V) lower than the voltage of the voltage Ein. The power feed system 1 illustrated in FIG. 1 further includes a non-insulated converter 20 (equivalent to the second converter according to the present invention) that receives the power of the voltage Vin supplied by the insulated converter 10 and produces power of voltage VL (equivalent to the third voltage according to the present invention, e.g. DC voltage of 3V) lower than the voltage Vin. The power feed system 1 illustrated in FIG. 1 further includes a voltage stabilizing circuit 40 provided between the insulated converter 10 and the non-insulated converter 20.

The voltage stabilizing circuit 40 monitors fluctuation of the voltage Vin, forms a current path between a power supply line 31 of the voltage Vin and a ground 32, and adjusts the amount of a current flowing in the current path according to the result of the monitoring, thereby stabilizing the voltage Vin. Incidentally, in FIG. 1, the voltage before stabilized by the voltage stabilizing circuit 40 is indicated with “Vin” and the voltage after stabilized by the voltage stabilizing circuit 40 is indicated with “Vout.”

The voltage stabilizing circuit 40 includes a capacitor 41 and a first resistance 42, which are connected in series between the power supply line 31 and the ground 32. The capacitor 41 is on the power supply line 31 side and the first resistance 42 is on the ground 32 side. Further, the voltage stabilizing circuit 40 includes a diode 43 whose cathode is connected to a connection node A between the capacitor 41 and the first resistance 42 and whose anode is connected to the ground 32. Furthermore, the voltage stabilizing circuit 40 includes: a second resistance 44 and a transistor 45 (that is a normal bipolar transistor, which is an example of the active element according to the present invention) that are connected in series between the power supply line 31 and the ground 32. The transistor 45 has a base (equivalent to the control terminal according to the present invention) connected to the connection node A so that the impedance changes according to the voltage of the connection node A.

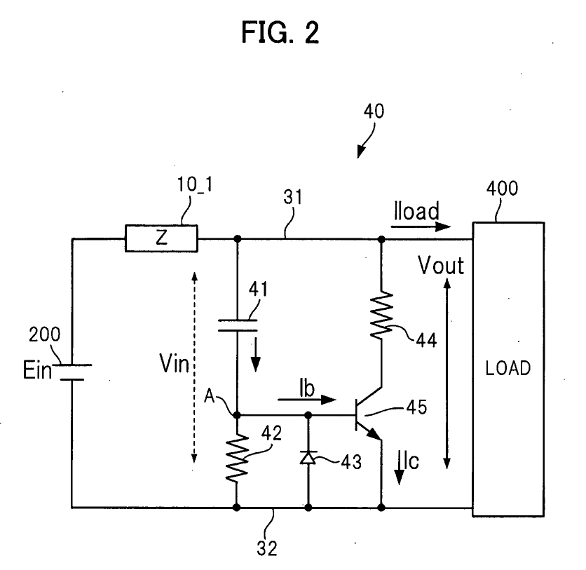

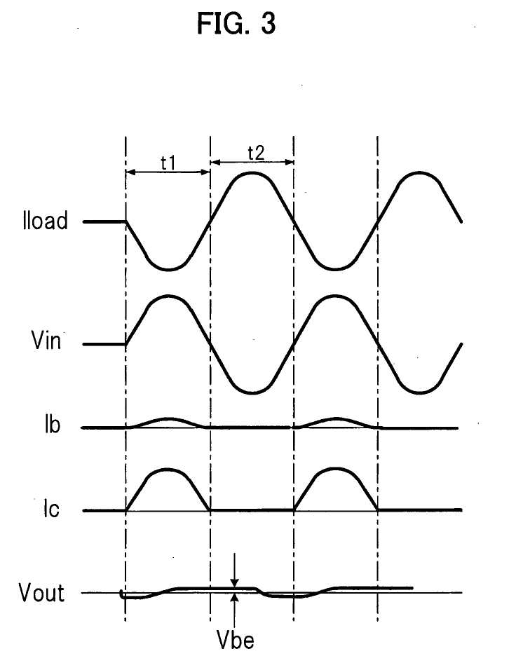

Here, operation of the voltage stabilizing circuit 40 will be described with reference to FIG. 2 and FIG. 3.

FIG. 2 is a diagram for explaining the structure and operation of the voltage stabilizing circuit illustrated in FIG. 1, and FIG. 3 is a diagram illustrating a waveform of each part in the voltage stabilizing circuit illustrated in FIG. 2.

In order to explain the operation of the voltage stabilizing circuit 40 illustrated in FIG. 1, FIG. 2 illustrates a simplified circuit structure of the power feed system 1 illustrated in FIG. 1. In other words, FIG. 2 illustrates: the power supply 200 of the voltage Ein; an impedance 10_1 parasitizing the insulated converter 10 and the power supply line; the voltage stabilizing circuit 40; and a load circuit 400 composed of the non-insulated converter 20 and the load circuit 300.

Here, it is assumed that a load current Iload flowing into the load circuit 400 drops during a period t1 illustrated in FIG. 3. Then, the voltage Vin (referred to as “input voltage Vin”) before stabilized by the voltage stabilizing circuit 40 rises. In response to this rise, a base current Ib flows into the transistor 45 through the capacitor 41, making the transistor 45 enter an active state, which causes a collector current Ic of hfe (current amplification factor) times larger than the base current Ib to flow into the collector of the transistor 45. As a result, a fluctuation current expressing the fluctuation (the amount of the rise in this example) of the voltage Vout (referred to as “output voltage Vout”) after stabilized by the voltage stabilizing circuit 40 is bypassed with the first resistance 42 and the collector current Ic of the transistor 45, so that the fluctuation of the output voltage Vout is made small. In other words, the amount of a fluctuation of the output voltage Vout is equivalent to a voltage rise realized by adding a voltage Vbe between the base and the emitter of the transistor 45 to the initial output voltage Vout expressed by the charge accumulated in the capacitor 41 at the initial point of time before the period t1.

Subsequently, it is assumed that the load current Iload rises during a period t2 illustrated in FIG. 3. Then, the input voltage Vin drops, causing a current to flow in a path from the diode 43 to the capacitor 41. In other words, the base current Ib and the collector current Ic do not flow. As a result, the amount of the fluctuation (the amount of the drop in this example) of the output voltage Vout is equivalent to a voltage drop of the diode 43. Here, the voltage drop of the diode 43 is approximately equal to the voltage Vbe between the base and the emitter of the transistor 45. For this reason, even if the load current Iload increases during the period t2, the amount of the fluctuation of the output voltage Vout is approximately equal to the voltage Vbe. Therefore, the output voltage Vout after stabilized by the voltage stabilizing circuit 40 is controlled to be a fluctuation that is about the same as the amplitude of the voltage Vbe, the center of which is the input voltage Vin earlier than the period t1 illustrated in FIG. 3 before stabilized by the voltage stabilizing circuit 40. Generally, the voltage Vbe of a transistor is equal to or less than 1V and thus, the amplitude range is between 2VP and P inclusive.

With the above-described structure, a capacitance C of the capacitor 41 illustrated in FIG. 2 can have the same effect as that in a case where a capacitor whose capacity is equivalent to a capacity obtained by multiplying the capacity C by the current amplification factor hfe of the transistor 45 is inserted between the power supply line 31 and the ground 32. For example, in a case where the capacitance C of the capacitor 41 is 100 μF and the current amplification factor hfe of the transistor 45 is 100, there would be produced a voltage suppressing effect approximately equal to that produced when a capacitor whose capacitance is 100 μF×100=10,000 μF is inserted between the power supply line 31 and the ground 32.

In the power feed system 1 of the present embodiment, when a load current flowing into the load 300 changes, the amount of a current flowing in the current path formed between the power supply line 31 and the ground 32 is adjusted so that the input voltage Vin from the insulated converter 10 is stabilized to serve as the output voltage Vout. Then, the power of this output voltage Vout is supplied to the non-insulated converter 20 that in turn supplies power of the voltage VL lower than the output voltage Vout to the load 300. Here, the voltage stabilizing circuit 40, which is provided to adjust the amount of a current flowing in the current path formed between the power supply line 31 and the ground 32, is composed of the capacitor 41, the transistor 45 and the like of small size. Therefore, as compared with the conventional technique in which the capacitor 110 of large size is provided between the power supply line 31 and the ground 32 illustrated in FIG. 5, it is possible to stably supply the power to the load 300 while keeping the circuit area and a cost increase small.

Also, in the power feed system 1 of the present embodiment, the insulated converter 10 with galvanic isolation established between input and output is provided and thus, the power feed system 1 is excellent in resistance to a surge voltage caused externally. Meanwhile, the non-insulated converter 20 is not provided with an isolation transformer or the like to establish galvanic isolation between input and output, making it possible to realize high-speed operation, which results in excellent load responsiveness. In addition, since the insulated converter 10 and the non-insulated converter 20 are both DC-DC converters of step-down type, they can preferably support a digital load such as a CPU that operates at a high speed with low voltage and heavy current.

Incidentally, the power feed system 1 of the present embodiment has been described by using the example in which only the voltage stabilizing circuit 40 is provided between the power supply line 31 and the ground 32. However, when a sufficient level of stability is not achieved with the voltage stabilizing circuit 40, a capacitor of small size may be additionally provided between the power supply line 31 and the ground 32 in parallel with the voltage stabilizing circuit 40. By doing so, it is possible to supply stable power to the load 300 while keeping the circuit area and a cost increase small.

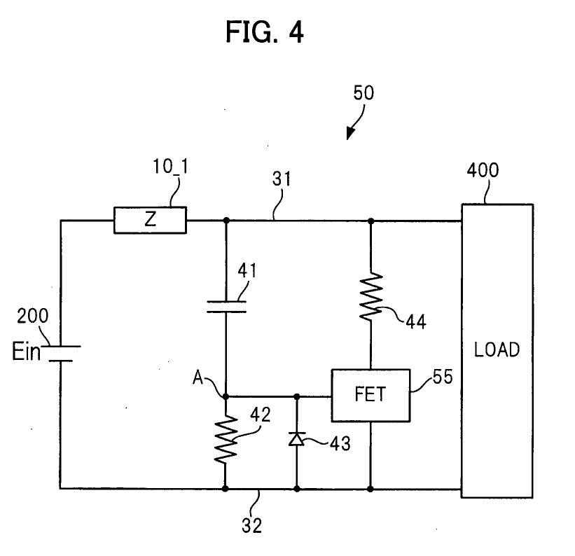

FIG. 4 is a diagram that illustrates the structure of a voltage stabilizing circuit different from the voltage stabilizing circuit illustrated in FIG. 1 and FIG. 2.

A voltage stabilizing circuit 50 illustrated in FIG. 4 is different from the voltage stabilizing circuit 40 illustrated in FIG. 1 and FIG. 2 in that the transistor 45 illustrated in FIG. 1 and FIG. 2 is replaced with a Field Effect Transistor (FET) 55. The FET 55 is another example of the active element according to the present invention and may be allowed to serve as the transistor 45.

Incidentally, in the embodiment described above, there has been used the combination of the insulated converter and the non-insulated converter as an example of the combination of the first converter and the second converter according to the present invention. The insulated converter is a converter with galvanic isolation established between input and output, which receives power supplied by the power source of the first voltage and produces power of the second voltage lower than the first voltage. The non-insulated converter is a converter that receives power of the second voltage from the insulated converter and produces power of the third voltage lower than the second voltage, thereby supplying the power of the third voltage to the load. However, the present invention is not limited to the combination of these insulated converter and non-insulated converter and may be any kind of combination as long as the combination is composed of: the first converter that receives power of the first voltage from the power source and produces power of the second voltage lower than the first voltage; and the second converter that receives, the power of the second voltage from the first converter, produces power of the third voltage lower than the second voltage, and supplies the power of the third voltage to the load.

Also, in the embodiment described above, the normal bipolar transistor 45 and the field effect transistor 55 have been used as examples of the active element. However, the active element is not limited to these examples and may be an Insulated Gate Bipolar Transistor (IGBT), an Static Induction Transistor (SIT) and the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A power feed system, comprising:
a first converter that receives power from a power source of a first voltage and produces power of a second voltage lower than the first voltage;
a second converter that receives the power of the second voltage from the first converter, produces power of a third voltage lower than the second voltage, and supplies the power of the third voltage to a load; and
a voltage stabilizing circuit that is provided between the first converter and the second converter and stabilizes the second voltage by monitoring a fluctuation of the second voltage, forming a current path between a power supply line of the second voltage and a ground, and adjusting the amount of a current flowing in the current path according to a result of the monitoring.

2. The power feed system according to claim 1, wherein the voltage stabilizing circuit comprises:
a capacitor and a first resistance that are connected in series between the power supply line and the ground, the capacitor being on a power-supply-line side and the first resistance being on a ground side;
a diode whose cathode is connected to a connection node between the capacitor and the first resistance and whose anode is connected to the ground; and
a second resistance and an active element that are connected in series between the power supply line and the ground, the active element including a control terminal connected to the connection node and changing impedance according to a voltage of the connection node.

3. The power feed system according to claim 1, wherein the first converter is an insulated converter with galvanic insulation between input and output, and the second converter is a non-insulated converter.

4. The power feed system according to claim 2, wherein the first converter is an insulated converter with galvanic insulation between input and output, and the second converter is a non-insulated converter.

5. The power feed system according to claim 4, wherein the active element is any one selected from among active elements such as a transistor, a FET, an IGBT and a SIT.

6. A voltage stabilization method in a power feed system that includes a first converter that receives power from a power source of a first voltage and produces power of a second voltage lower than the first voltage and a second converter that receives the power of the second voltage from the first converter, produces power of a third voltage lower than the second voltage, and supplies the power of the third voltage to a load, the voltage stabilization method comprising:
monitoring a fluctuation of the second voltage, forming a current path between a power supply line of the second voltage and a ground, and adjusting the amount of a current flowing in the current path according to a result of the monitoring.
